(19) United States
(12) Patent Application Publication
(10) Pub. No.: US 2026/0105196 A1
(43) Pub. Date: Apr. 16, 2026

(54) ELECTRONIC DEVICE AND METHOD TO PROTECT MEMORY FROM JAMMING

(71) Applicant: MEDIATEK INC., Hsinchu City (TW)

(72) Inventors: Chih-Ming WANG, Hsinchu City (TW); Chun-Ping WANG, Hsinchu City (TW)

(21) Appl. No.: 18/917,418

(22) Filed: Oct. 16, 2024

(51) Int. Cl. G06F 21/78

(52) U.S. Cl. CPC G06F 21/78

(57) ABSTRACT

An electronic device includes a memory, a modem, and a DVFS controller. The memory selectively works at a plurality of operating points. Each operating point corresponds to an operating voltage and an operating frequency. The modem outputs RF signals based on multiple scenarios. The DVFS controller is electrically connected to the modem and the memory. The DVFS controller selects one of the operating points. The DVFS controller masks at least one of the operating points associated with interference of the modem based on power of the RF signals to protect the memory from jamming, and releases the masked operating point based on the power of the RF signals.

### BACKGROUND OF THE INVENTION

### Field of the Invention

The present invention relates to an electronic device, and, in particular, to an electronic device and a method to protect a memory from jamming.

### Description of the Related Art

With current 5G mobile phones, there have been cases where bitflip occurs when the function of dynamic voltage and frequency scaling (DVFS) is turned on. If the hardware anti-interference design is not done well enough, when the RF signals are transmitted at high power, it will interfere with the DRAM operating clock, causing DRAM instability and data errors.

### BRIEF SUMMARY OF THE INVENTION

An embodiment of the present invention provides an electronic device including a memory, a modem, and a DVFS controller. The memory selectively works at a plurality of operating points. Each operating point corresponds to an operating voltage and an operating frequency. The modem outputs RF signals based on multiple scenarios. The DVFS controller is electrically connected to the modem and the memory. The DVFS controller selects one of the operating points. The DVFS controller masks at least one of the operating points associated with interference of the modem based on power of the RF signals to protect the memory from jamming, and releases the masked operating point based on the power of the RF signals.

According to the electronic device described above, when the power of the RF signals output from the modem is higher than a threshold, the DVFS controller masks some of the operating points to protect the memory from jamming.

According to the electronic device described above, when the power of the RF signals output from the modem is at or under the threshold, the DVFS controller releases the marked operating points.

According to the electronic device described above, when the modem is turned on, the DVFS controller masks some of the operating points to protect the memory from jamming.

According to the electronic device described above, when the modem is turned off, the DVFS controller releases the marked operating points.

According to the electronic device described above, when the modem detects a voltage jitter on its power source and the voltage drop on its power source is higher than a threshold, the DVFS controller masks some of the operating points to protect the memory from jamming.

According to the electronic device described above, when the modem detects the voltage jitter on its power source and the voltage drop on its power source is at or under the threshold, the DVFS controller releases the marked operating points.

According to the electronic device described above, when the modem is operated at a predetermined frequency, the DVFS controller masks some of the operating points to protect the modem from jamming.

According to the electronic device described above, when the power of the RF signals output from the modem is higher than the threshold, the modem sends an enable signal to the DVFS controller, and the DVFS controller masks some of the operating points to protect the memory from jamming based on the enable signal.

According to the electronic device described above, when the power of the RF signals output from the modem is at or under the threshold, the modem sends a disable signal to the DVFS controller, and the DVFS controller releases the marked operating points based on the disable signal.

According to the electronic device described above, after the DVFS controller masks at least one of the operating points, the DVFS controller selects an operating point with a higher operating frequency than that of the masked operating points.

According to the electronic device described above, when the power of the RF signals output from the modem is higher than the threshold, the DVFS controller selects a new operating point with a higher operating voltage than that of an original operating point.

According to the electronic device described above, when the power of the RF signals output from the modem is at or under the threshold, the DVFS controller selects the original operating point.

An embodiment of the present invention also provides a method to protect a memory from jamming. The method is applied to an electronic device including the memory, a modem, and a dynamic voltage and frequency scaling (DVFS) controller. The method includes the following steps. The memory selectively works at a plurality of operating points. Each operating point corresponds to an operating voltage and an operating frequency. Radio frequency (RF) signals are output based on multiple scenarios. One of the plurality operating points is selected. At least one of the operating points associated with interference of the modem is masked based on power of the RF signals to protect the memory from jamming. The masked operating points are released based on the power of the RF signals.

According to the method described above, the steps of masking at least one of the operating points associated with interference of the modem based on power of the RF signals to protect the memory from jamming include the following steps. Some of the operating points are masked to protect the memory from jamming in response to the power of the RF signals output from the modem being higher than a threshold. The marked operating points are released in response to the power of the RF signals output from the modem being at or under the threshold.

According to the method described above, the steps of masking at least one of the operating points associated with interference of the modem based on power of the RF signals to protect the memory from jamming include the following steps. Some of the operating points are marked to protect the memory from jamming in response to the modem being turned on. The marked operating points are released in response to the modem being turned off.

According to the method described above, the steps of masking at least one of the operating points associated with interference of the modem based on power of the RF signals to protect the memory from jamming include the following steps. Some of the operating points are masked to protect the memory from jamming in response to the modem detecting a voltage jitter on its power source and the voltage drop on its power source being higher than a threshold. The marked operating points are released in response to the modem detecting the voltage jitter on its power source and the voltage drop on its power source being at or under the threshold.

The method further includes the following steps. Some of the operating points are masked to protect the modem from jamming in response to the modem being operated at a predetermined frequency.

According to the method described above, the step of masking some of the operating points to protect the memory from jamming in response to the power of the RF signals output from the modem being higher than the threshold includes the following steps. An enable signal is sent to the DVFS controller in response to the power of the RF signals output from the modem being higher than the threshold. Some of the operating points are marked to protect the memory from jamming based on the enable signal.

According to the method described above, the step of releasing the masked operating points in response to the power of the RF signals output from the modem being at or under the threshold includes the following steps. A disable signal is sent to the DVFS controller in response to the power of the RF signals output from the modem being at or under the threshold. The marked operating points are released based on the disable signal.

The method further includes the following steps. An operating point with a higher operating frequency than that of the masked operating points is selected after masking at least one of the operating points. The operating voltage and the operating frequency corresponding to the selected operating point are output to the memory.

The method further includes the following steps. A new operating point with a higher operating voltage that that of an original operating point is selected in response to the power of the RF signals output from the modem being higher than the threshold. The original operating point is selected in response to the power of the RF signals output from the modem being at or under the threshold.

### BRIEF DESCRIPTION OF THE DRAWINGS

The present invention can be more fully understood by reading the subsequent detailed description and examples with references made to the accompanying drawings, wherein:

FIG. 1 shows a schematic diagram of an electronic device 100 in accordance with some embodiments of the present invention;

FIG. 2 shows a schematic diagram of multiple operating points and the electronic device 100 in FIG. 1 masking some of operating points in accordance with some embodiments of the present invention;

FIG. 3 shows a schematic diagram of multiple operating points and the electronic device 100 in FIG. 1 increasing a driving voltage in a selected operating point in accordance with some embodiments of the present invention; and

FIG. 4 shows a flow chart of a method to protect a memory from jamming in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” or “include” used in the present invention are used to indicate the existence of specific technical features, values, method steps, operations, units or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, or materials used in specific embodiments. However, the drawings should not be construed as defining or limiting the scope or properties encompassed by these embodiments. For example, for clarity, the relative size, thickness, and position of each layer, each area, or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, and “third” are used to describe components. They are not used to indicate the priority order of or advance relationship, but only to distinguish components with the same name.

It should be noted that the technical features in different embodiments described in the following can be replaced, recombined, or mixed with one another to constitute another embodiment without depart in from the spirit of the present invention.

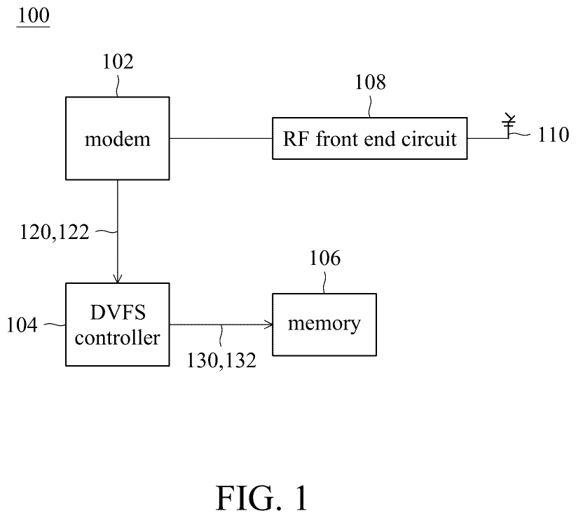

FIG. 1 shows a schematic diagram of an electronic device 100 in accordance with some embodiments of the present invention. As shown in FIG. 1, the electronic device 100 includes a modem 102, a dynamic voltage and frequency scaling (DVFS) controller 104, a memory 106, a radio frequency (RF) front end circuit 108, and an antenna 110. The DVFS controller 104 is electrically connected between the modem 102 and the memory 106. The RF front end circuit 108 is electrically connected between the modem 102 and the antenna 110. The memory 106 selectively works at a plurality of operating points. Each operating point corresponds to an operating voltage and an operating frequency. The modem 102 outputs RF signals based on multiple scenarios through the RF front end circuit 108 and the antenna 110. The DVFS controller 104 selects one of the plurality of operating points. The DVFS controller 104 masks at least one of the operating points associated with interference of the modem 102 based on power of the RF signals to protect the memory 106 from jamming, and releases the masked operating points based on the power of the RF signals.

In detail, in some embodiments, when the power of the RF signals output from the modem 102 is higher than a threshold, the modem 102 sends an enable signal 120 to the DVFS controller 104, so that the DVFS controller 104 masks some of the operating points to protect the memory 106 from jamming based on the enable signal 120. In some embodiments, when the power of the RF signals output from the modem 102 is higher than the threshold, the DVFS controller 104 selects a new operating point with a higher operating voltage than that of an original operating point. In some embodiments, when the power of the RF signals output from the modem 102 is at or under the threshold, the modem 102 sends a disable signal 122 to the DVFS controller 104, so that the DVFS controller 104 releases the masked operating points based on the disable signal 122. In some embodiments, when the power of the RF signals output from the modem 102 is at or under the threshold, the DVFS controller 104 selects the original operating point.

In some embodiments, when the modem 102 is operated at a predetermined frequency, the DVFS controller 104 masks some of the operating points to protect the modem 102 from jamming. In some embodiments, after the DVFS controller 104 masks the at least one of the operating points, the DVFS controller 104 selects an operating point with a higher operating frequency than that of the masked operating points.

In some embodiments, when the modem 102 is turned on, the DVFS controller 104 masks some of the operating points to protect the memory 106 from jamming. For example, when the modem 102 is turned on, the modem 102 sends the enable signal 120 to the DVFS controller 104, so that the DVFS controller 104 masks some of the operating points to protect the memory 106 from jamming based on the enable signal 120. That is, the DVFS controller 104 does not use the masked operating points to drive the memory 106, but selects an operating point with a higher operating frequency than that of the masked operating points, and outputs a driving voltage 130 and a driving clock 132 with the frequency corresponding to the selected operating point to the memory 106. In some embodiments, when the modem 102 is turned off, the modem 102 sends the disable signal 122 to the DVFS controller 104, so that the DVFS controller 104 releases the masked operating points based on the disable signal 122. That is, after the masked operating points are released, the DVFS controller 104 is able to reuse the masked operating points that have been released to drive the memory 106.

In some embodiments, when the modem detects a voltage jitter on its power source and the voltage drop on its power source is higher than a threshold, the modem 102 sends an enable signal 120 to the DVFS controller 104, so that the DVFS controller 104 masks some of the operating points to protect the memory 106 from jamming based on the enable signal 120. That is, the DVFS controller 104 does not use the masked operating points to drive the memory 106, but selects an operating point with a higher operating frequency than that of the masked operating points, and outputs the driving voltage 130 and the driving clock 132 with the frequency corresponding to the selected operating point to the memory 106. In some embodiments, when the modem 102 detects the voltage jitter on its power source (not shown) and the voltage drop on its power source is at or under the threshold, the modem 102 sends the disable signal 122 to the DVFS controller 104, so that the DVFS controller 104 releases the masked operating points based on the disable signal 122.

In some embodiments, when the power of the RF signals output from the modem 102 is higher than the threshold, the DVFS controller 104 increases the driving voltage 130 in the selected operating point. For example, the driving voltage 130 is increased from 0.3V to 0.5V, but the present invention is not limited thereto. When the power of the RF signals output from the modem 102 is at or under the threshold, the DVFS controller 104 recovers the driving voltage 130 in the selected operating point. For example, the driving voltage 130 is recovered from 0.5V to 0.3V.

In some embodiments, when the modem 102 is turned on, the DVFS controller 104 increases the driving voltage 130 in the selected operating point. For example, the driving voltage 130 is increased from 0.3V to 0.5V, but the present invention is not limited thereto. When the modem 102 is turned off, the DVFS controller 104 recovers the driving voltage 130 in the selected operating point. For example, the driving voltage 130 is recovered from 0.5V to 0.3V.

In some embodiments, when the modem 102 detects a voltage jitter on its power source and the voltage drop on its power source is higher than the threshold, the DVFS controller 104 increases the driving voltage 130 in the selected operating point. For example, the driving voltage 130 is increased from 0.3V to 0.5V, but the present invention is not limited thereto. When the modem 102 detects the voltage jitter on its power source and the voltage drop on its power source is at or under the threshold, the DVFS processor 104 recovers the driving voltage 130 in the selected operating point. For example, the driving voltage 130 is recovered from 0.5V to 0.3V.

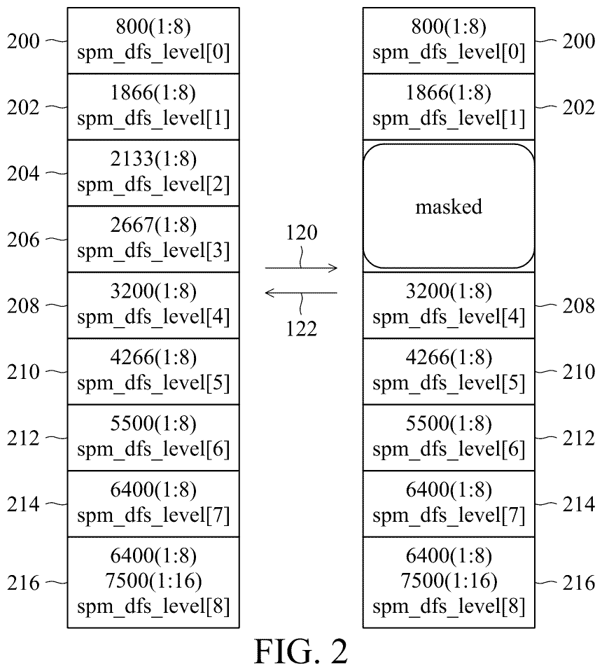

FIG. 2 shows a schematic diagram of multiple operating points and the electronic device 100 in FIG. 1 masking some of the operating points in accordance with some embodiments of the present invention. As shown in FIG. 2, the DVFS controller 104 outputs a driving voltage 130 and a driving clock 132 with a frequency to the memory 106 based on multiple operating points, for example, including an operating point 200, an operating point 202, an operating point 204, an operating point 206, an operating point 208, an operating point 210, an operating point 212, an operating point 214, and an operating point 216. In some embodiments of FIG. 2, the driving clock 132 in the operating points 200 to 216 are set in a register spm_dfs_level[X], wherein X is equal to 0 to 8. For example, the register is set to spm_dfs_level[0] in the operating point 200. When the operating point 200 is selected, the DVFS controller 104 outputs the driving voltage 130 of 0.3V and the driving clock 132 with the frequency of 400 MHz (marked as 800(1:8) in FIG. 2) to the memory 106. The register is set to spm_dfs_level[1] in the operating point 202. When the operating point 202 is selected, the DVFS controller 104 outputs the driving voltage 130 of 0.3V and the driving clock 132 with the frequency of 833 MHz (marked as 1866(1:8) in FIG. 2) to the memory 106. The register is set to spm_dfs_level[2] in the operating point 204. When the operating point 204 is selected, the DVFS controller 104 outputs the driving voltage 130 of 0.3V and the driving clock 132 with the frequency of 1067 MHz (marked as 2133(1:8) in FIG. 2) to the memory 106. The register is set to spm_dfs_level[3] in the operating point 206. When the operating point 206 is selected, the DVFS controller 104 outputs the driving voltage 130 of 0.3V and the driving clock 132 with the frequency of 1334 MHz (marked as 2667(1:8) in FIG. 2) to the memory 106.

Similarly, the register is set to spm_dfs_level[4] in the operating point 208. When the operating point 208 is selected, the DVFS controller 104 outputs the driving voltage 130 of 0.3V and the driving clock 132 with the frequency of 1600 MHz (marked as 3200(1:8) in FIG. 2) to the memory 106. The register is set to spm_dfs_level[5] in the operating point 210. When the operating point 210 is selected, the DVFS controller 104 outputs the driving voltage 130 of 0.3V and the driving clock 132 with the frequency of 2133 MHz (marked as 4266(1:8) in FIG. 2) to the memory 106. The register is set to spm_dfs_level[6] in the operating point 212. When the operating point 212 is selected, the DVFS controller 104 outputs the driving voltage 130 of 0.3V and the driving clock 132 with the frequency of 2750 MHz (marked as 5500 (1:8) in FIG. 2) to the memory 106. The register is set to spm_dfs_level[7] in the operating point 214. When the operating point 214 is selected, the DVFS controller 104 outputs the driving voltage 130 of 0.3V and the driving clock 132 with the frequency of 3200 MHz (marked as 6400(1:8) in FIG. 2) to the memory 106. The register is set to spm_dfs_level[8] in the operating point 216. When the operating point 216 is selected, the DVFS controller 104 outputs the driving voltage 130 of 0.3V and the driving clock 132 with the frequency of 3200 MHz or 3750 MHz (marked as 6400(1:8) or 7500(1:16) in FIG. 2) to the memory 106.

As shown in FIG. 2, after receiving the enable signal 120 from the modem 102, the DVFS controller 104 masks the operating points 204 and 206 to protect the memory 106 from jamming. That is, the DVFS controller 104 does not outputs the driving voltage 130 of 0.3V and the driving clock 132 with the frequency of 1067 MHz to the memory 106. Similarly, the DVFS controller 104 also does not outputs the driving voltage 130 of 0.3V and the driving clock 132 with the frequency of 1334 MHz to the memory 106. In contrast, after the operating points 204 and 206 are masked, the DVFS controller 104 selects the operating point 208, and outputs the driving voltage 130 of 0.3V and the driving clock 132 with the frequency of 1600 MHz to the memory 106. In some embodiments, after the operating points 204 and 206 are masked, the DVFS controller 104 selects the operating point 210, and outputs the driving voltage 130 of 0.3V and the driving clock 132 with the frequency of 2133 MHz to the memory 106, but the present invention is not limited thereto.

As shown in FIG. 2, after receiving the disable signal 122 from the modem 102, the DVFS controller 104 releases the masked operating points 204 and 206. That is, the DVFS controller 104 is able to reuse the masked operating points 204 and 206 that have been released to drive the memory 106.

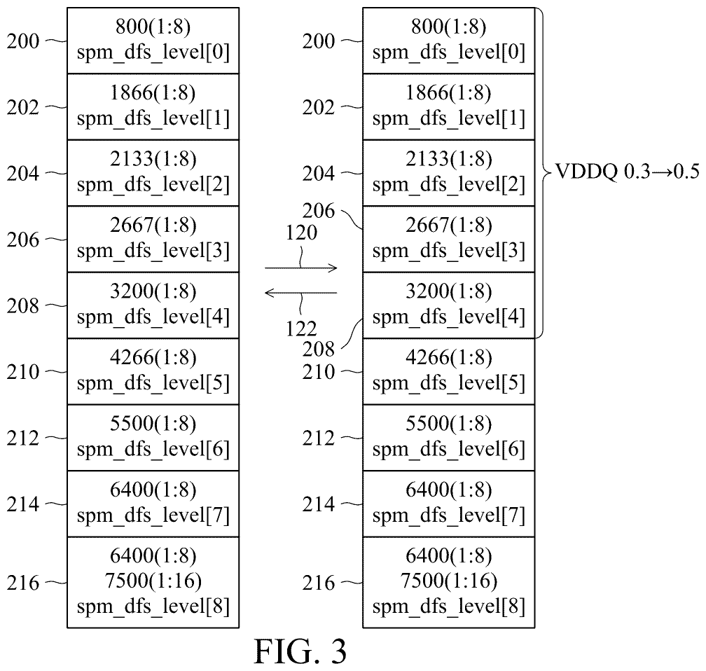

FIG. 3 shows a schematic diagram of multiple operating points and the electronic device 100 in FIG. 1 increasing a driving voltage in a selected operating point in accordance with some embodiments of the present invention. As shown in FIG. 3, the DVFS controller 104 outputs the driving voltage 130 and the driving clock 132 with a frequency to the memory 106 based on multiple operating points, for example, including the operating point 200, the operating point 202, the operating point 204, the operating point 206, the operating point 208, the operating point 210, the operating point 212, the operating point 214, and the operating point 216. After receiving the enable signal 120 from the modem 102, the DVFS controller 104 increases the driving voltage 132 (for example, marked as VDDQ in FIG. 3) in the selected operating point, for example, the operating point 200, the operating point 202, the operating point 204, the operating point 206, or the operating point 208, from 0.3V to 0.5V to increase the anti-interference ability of memory 106. After receiving the disable signal 122 from the modem 102, the DVFS controller 104 recovers the driving voltage 132 in the selected operating point, for example, the operating point 200, the operating point 202, the operating point 204, the operating point 206, or the operating point 208, from 0.5V to 0.3V.

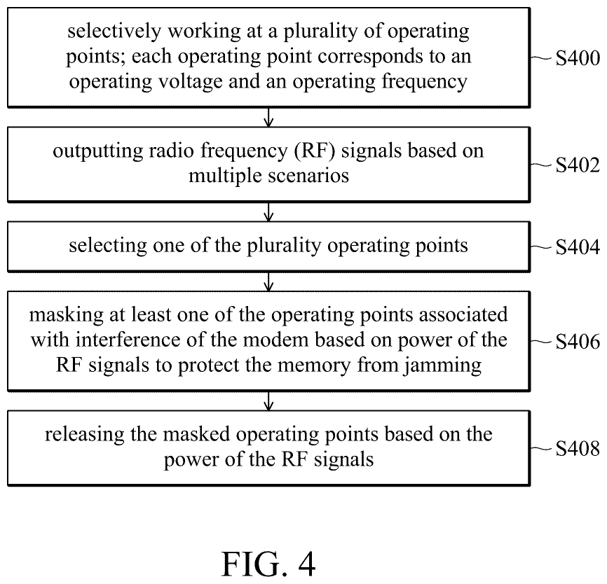

FIG. 4 shows a flow chart of a method to protect a memory from jamming in accordance with some embodiments of the present invention. The method to protect the memory from jamming is applied to an electronic device (for example, the electronic device 100 in FIG. 1) including the memory (the memory 106), a modem (the modem 102), and a DVFS controller (the DVFS controller 104). The method includes the following steps. The memory selectively works at a plurality of operating points. Each operating point corresponds to an operating voltage and an operating frequency (step S400). Radio frequency (RF) signals are output based on multiple scenarios (step S402). One of the plurality operating points is selected (step S404). At least one of the operating points associated with interference of the modem is masked based on power of the RF signals to protect the memory from jamming (step S406). The masked operating points are released based on the power of the RF signals (step S408). In some embodiments, step S402 is executed by the modem. Steps S404 and S406, and S408 are executed by the DVFS controller.

In some embodiments, steps S404, S406 and S408 include the following steps. Some of the operating points are masked to protect the memory from jamming in response to the power of the RF signals output from the modem being higher than a threshold. The marked operating points are released in response to the power of the RF signals output from the modem being at or under the threshold. In some embodiments, the step of masking some of the operating points to protect the memory from jamming in response to the power of the RF signals output from the modem being higher than the threshold includes the following steps. An enable signal (for example, the enable signal 120) is sent to the DVFS controller in response to the power of the RF signals output from the modem being higher than the threshold. Some of the operating points are masked to protect the memory from jamming based on the enable signal. In some embodiments, the step of releasing the masked operating points in response to the power of the RF signals output from the modem being at or under the threshold includes the following steps. A disable signal (for example, the disable signal 122) is sent to the DVFS controller in response to the power of the RF signals output from the modem is at or under the threshold. The masked operating points are released based on the disable signal.

In some embodiments, the method further includes the following steps. An operating point with a higher operating frequency than that of the masked operating points is selected after masking at least one of the operating points. The operating voltage and the operating frequency corresponding to the selected operating point are output to the memory.

In some embodiments, steps S404, S406 and S408 include the following steps. Some of the operating points are masked to protect the memory from jamming in response to the modem is turned on. The masked operating points are released in response to the modem is turned off. In some embodiments, the step of masking at least one of the operating points associated with interference of the modem based on power of the RF signals to protect the memory from jamming includes the following steps. An enable signal (for example, the enable signal 120) is sent to the DVFS controller in response to the modem being turned on. Some of the operating points are masked to protect the memory from jamming based on the enable signal. In some embodiments, the step of releasing the masked operating points in response to the modem being turned off includes the following steps. A disable signal (for example, the disable signal 122) is sent to the DVFS controller in response to the modem being turned off. The masked operating points are released based on the disable signal.

In some embodiments, steps S404, S406 and S408 include the following steps. Some of the operating points are masked to protect the memory from jamming in response to the modem detecting a voltage jitter on its power source and the voltage drop on its power source being higher than a threshold. The masked operating points are released in response to the modem detecting the voltage jitter on its power source and the voltage drop on its power source being at or under the threshold. In some embodiments, the step of masking some of the operating points to protect the memory from jamming in response to the modem detecting the voltage jitter on its power source and the voltage drop on its power source being higher than the threshold includes the following steps. An enable signal (for example, the enable signal 120) is sent to the DVFS controller in response to the modem detecting the voltage jitter on its power source and the voltage drop on its power source being higher than the threshold. Some of the operating points are masked to protect the memory from jamming based on the enable signal.

In some embodiments, the step of releasing the masked operating points in response to the modem detecting the voltage jitter on its power source and the voltage drop on its power source being at or under the threshold includes the following steps. A disable signal (for example, the disable signal 122) is sent to the DVFS controller in response to the modem detecting the voltage jitter on its power source and the voltage drop on its power source being at or under the threshold. The masked operating points are released based on the disable signal.

The electronic device 100 and the method to protect the memory from jamming first notifies the DVFS controller to mask the operating points which may be affected by interference before transmitting high power in the RF band. The electronic device 100 and the method to protect the memory from jamming notifies the DVFS controller that there is no need to mask the operating points which may be affected by interference after there is no need to transmit high power. The electronic device 100 and the method to protect the memory from jamming allows most scenarios to operate in these operating points to obtain better power gain.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a memory, configured to selectively work at a plurality of operating points, wherein each operating point corresponds to an operating voltage and an operating frequency;
a modem, configured to output radio frequency (RF) signals based on multiple scenarios;
a dynamic voltage and frequency scaling (DVFS) controller, electrically connected to the modem and the memory, configured to select one of the plurality of operating points, wherein the DVFS controller masks at least one of the operating points associated with interference of the modem based on power of the RF signals to protect the memory from jamming, and releases the masked operating points based on the power of the RF signals.

2. The electronic device as claimed in claim 1, wherein when the power of the RF signals output from the modem is higher than a threshold, the DVFS controller masks some of the operating points to protect the memory from jamming, when the power of the RF signals output from the modem is at or under the threshold, the DVFS controller releases the masked operating points.

3. The electronic device as claimed in claim 1, wherein when the modem is turned on, the DVFS controller masks some of the operating points to protect the memory from jamming, when the modem is turned off, the DVFS controller releases the masked operating points.

4. The electronic device as claimed in claim 1, wherein when the modem detects a voltage jitter on its power source and a voltage drop on its power source is higher than a threshold, the DVFS controller masks some of the operating points to protect the memory from jamming.

5. The electronic device as claimed in claim 4, wherein when the modem detects the voltage jitter on its power source and the voltage drop on its power source is at or under the threshold, the DVFS controller releases the masked operating points.

6. The electronic device as claimed in claim 1, when the modem is operated at a predetermined frequency, the DVFS controller masks some of the operating points to protect the modem from jamming.

7. The electronic device as claimed in claim 2, wherein when the power of the RF signals output from the modem is higher than the threshold, the modem sends an enable signal to the DVFS controller, and the DVFS controller masks some of the operating points to protect the memory from jamming based on the enable signal.

8. The electronic device as claimed in claim 1, wherein when the power of the RF signals output from the modem is at or under the threshold, the modem sends a disable signal to the DVFS controller, and the DVFS controller releases the masked operating points based on the disable signal.

9. The electronic device as claimed in claim 2, wherein after the DVFS controller masks the at least one of the operating points, the DVFS controller selects an operating point with a higher operating frequency than that of the masked operating points.

10. The electronic device as claimed in claim 2, wherein when the power of the RF signals output from the modem is higher than the threshold, the DVFS controller selects a new operating point with a higher operating voltage than that of an original operating point.

11. The electronic device as claimed in claim 10, wherein when the power of the RF signals output from the modem is at or under the threshold, the DVFS controller selects the original operating point.

12. A method to protect a memory from jamming, applied to an electronic device comprising the memory, a modem, and a dynamic voltage and frequency scaling (DVFS) controller, comprising:
selectively working at a plurality of operating points; wherein each operating point corresponds to an operating voltage and an operating frequency;
outputting radio frequency (RF) signals based on multiple scenarios;
selecting one of the plurality operating points;
masking at least one of the operating points associated with interference of the modem based on power of the RF signals to protect the memory from jamming, and
releasing the masked operating points based on the power of the RF signals.

13. The method as claimed in claim 12, wherein the step of masking at least one of the operating points associated with interference of the modem based on power of the RF signals to protect the memory from jamming, comprises:
masking some of the operating points to protect the memory from jamming in response to the power of the RF signals output from the modem being higher than a threshold; and
releasing the masked operating points in response to the power of the RF signals output from the modem being at or under the threshold.

14. The method as claimed in claim 12, wherein the step of masking at least one of the operating points associated with interference of the modem based on power of the RF signals to protect the memory from jamming, comprises:
masking some of the operating points to protect the memory from jamming in response to the modem being turned on; and
releasing the masked operating points in response to the modem being turned off.

15. The method as claimed in claim 12, wherein the step of masking at least one of the operating points associated with interference of the modem based on power of the RF signals to protect the memory from jamming, comprises:
masking some of the operating points to protect the memory from jamming in response to the modem detecting a voltage jitter on its power source and the voltage drop on its power source being higher than a threshold; and
releasing the masked operating points in response to the modem detecting the voltage jitter on its power source and the voltage drop on its power source being at or under the threshold.

16. The method as claimed in claim 12, further comprising:
masking some of the operating points to protect the modem from jamming in response to the modem being operated at a predetermined frequency.

17. The method as claimed in claim 13, wherein the step of masking some of the operating points to protect the memory from jamming in response to the power of the RF signals output from the modem being higher than the threshold, comprises:
sending an enable signal to the DVFS controller in response to the power of the RF signals output from the modem being higher than the threshold; and
masking some of the operating points to protect the memory from jamming based on the enable signal.

18. The method as claimed in claim 13, wherein the step of releasing the masked operating points in response to the power of the RF signals output from the modem being at or under the threshold, comprises:
sending a disable signal to the DVFS controller in response to the power of the RF signals output from the modem being at or under the threshold; and
releasing the masked operating points based on the disable signal.

19. The method as claimed in claim 13, further comprising:
selecting an operating point with a higher operating frequency than that of the masked operating points after masking at least one of the operating points; and
outputting the operating voltage and the operating frequency corresponding to the selected operating point to the memory.

20. The method as claimed in claim 13, further comprising:
selecting a new operating point with a higher operating voltage that that of an original operating point in response to the power of the RF signals output from the modem being higher than the threshold; and
selecting the original operating point in response to the power of the RF signals output from the modem being at or under the threshold.
